(19) United States
(12) Patent Application Publication
(10) Pub. No.: US 2010/0038203 A1
(43) Pub. Date: Feb. 18, 2010

(54) WRAP SPRING BRAKE ON OUTPUT VEHICLE TRANSMISSION SHAFT

(75) Inventor: Jonathan Charles Wheals, Warwickshire (GB)

Correspondence Address: GIFFORD, KRASS, SPRINKLE,ANDERSON & CITKOWSKI, P.C, PO BOX 7021, TROY, MI, 48007-7021, US

(73) Assignee: Ricardo UK Ltd, West Sussex (GB)

(21) Appl. No.: 12/444,452

(22) PCT Filed: Oct. 15, 2007
(86) PCT No.: PCT/GB07/03930

§ 371 Date: Aug. 28, 2009

(30) Foreign Application Priority Data
Oct. 13, 2006 (GB) 0620347.5

(51) Int. Cl. B60W 10/10; F16D 63/00

(52) U.S. Cl. 192/218; 188/67

(57) ABSTRACT

A wrap spring moves from a relaxed state to an energised state for braking rotation of the output shaft in a vehicle transmission. The wrap spring may constrict for engagement on the shaft or expand for engagement with an adjacent ground member. Two wrap springs, concentric or axially spaced, provide bi-directional braking. A split ring energises both wrap springs, e.g. using an epicyclic differential arrangement to move opposing ring portions in opposite directions The wrap spring may be mounted in a relaxed state for rotation with the shaft, with a mechanism for inducing drag torque to energise the spring for a braking operation. Means is provided preventing an actuator from energising the wrap spring, e.g. if the shaft is rotating above a predetermined speed.

The present invention relates to a brake device, more particularly, but not exclusively, to an anti roll-back device and/or a park brake device for a vehicle.

Vehicle roll-back is commonly encountered when attempting to launch a vehicle up a gradient from a stationary condition, particularly in the case of vehicles having dry clutch transmissions. Pawl type brake devices are known for preventing movement of the vehicle when parked, and it follows that these may be used for anti-roll functions. However, under frequent part load transitions, e.g. when launching up a gradient, such pawl-type devices are not particularly durable.

It is an object of the invention to provide an improved brake device for reducing or preventing roll-back in vehicles.

According to one aspect of the invention, there is provided a brake device, including an output shaft and a wrap spring mounted around said shaft wherein the wrap spring is arranged for moving from a relaxed state to an energised state for braking rotation of the shaft.

The brake device is particularly suited to anti-roll applications for vehicles, since it provides infinite resolution, as opposed to the stepped resolution of conventional pawl type devices. The brake device also provides smooth release under load, unlike conventional pawl devices.

The shaft preferably forms part of the output shaft of a vehicle transmission. The transmission preferably includes a transmission casing with the brake device housed within the casing.

The wrap spring may be arranged to constrict from its relaxed state for engagement on the shaft or may be arranged to expand from its relaxed state for engagement with an adjacent ground member.

The brake device preferably includes a pair of wrap springs arranged for bi-directional braking of the shaft, e.g. for use as a park brake preventing forward and rear movement. The wrap springs may be concentric with one another or may be axially spaced from one another along the shaft. The brake device preferably includes single input for energising both wrap springs, win which case the device may include a ring arranged for receiving input from said actuator, the ring having a first portion movable to energise a first of said wrap springs and a second portion movable to energise a second of said wrap springs. An epicyclic differential arrangement may be provided for moving the first and second ring portions in opposite directions.

The or each wrap spring is preferably mounted in a relaxed state for rotation with the shaft, with a mechanism provided for inducing a drag torque at a free end of the spring, in order to energise the spring for a braking operation.

The drag torque mechanism may include a ring which is attached to one end of the wrap spring and is rotatable about the shaft, and a loop or coil arranged annular to said ring, wherein the loop or coil can be tensioned and brought into contact with the ring, in order to create drag on the ring and thereby energise the wrap spring.

The brake device may include an actuator for energising the wrap spring and a safety mechanism arranged for selectively disabling the energising operation of the actuator and/or a safety mechanism arranged for selectively preventing movement of a free end of the wrap spring. The safety mechanism may take the form of an interlock device for locking engagement with a free end of the actuator or wrap spring or for blocking movement of the actuator.

The brake device may include an actuator element which is movable for energising the wrap spring, and a mechanism configured for preventing operation of the actuator element if the shaft is rotating above a predetermined speed. This overcomes a drawback of wrap springs, namely their tendency to engage at any speed (which may be hazardous in vehicle applications). The mechanism preferably includes a blocking element which is arranged to block movement of the actuator element when the shaft is rotating at speed. Moreover, the mechanism preferably includes opposing dogs that are configured to inter-engage only when the shaft speed is below a predetermined threshold, in order to permit the blocking element to move from a blocking position to a non-blocking position.

According to another aspect of the invention, there is also provided a vehicle transmission incorporating a brake device according to the above aspect of the invention.

According to another aspect of the invention, there is also provided a vehicle transmission incorporating an anti roll device, the vehicle transmission including an output shaft and the anti roll device including a wrap spring mounted around said shaft, wherein the spring can be tensioned so as to tighten around said shaft and prevent or retard rotation thereof in a first direction.

In preferred embodiments, the shaft is coupled to at least one road wheel of a vehicle. In the most preferred embodiments, the shaft forms part of the output shaft of a vehicle transmission. It is particularly preferred if transmission includes a casing and the anti roll device is housed within tile casing.

According to another aspect of the invention, there is provided a brake device including a wrap spring arranged for braking a rotatable shaft, either by constriction (i.e. to wrap down on to the shaft) or by expansion (i.e. to wrap out and engage a concentric annulus).

In preferred embodiments, the actuator includes a latching mechanism, which is operable to selectively hold the spring in tension.

There is also provided a vehicle transmission including a brake device according to the above aspect of the invention.

Other aspects and features of the invention will be readily apparent from the claims and following description of preferred embodiments, made by way of example only, with reference to the accompanying drawings, in which:

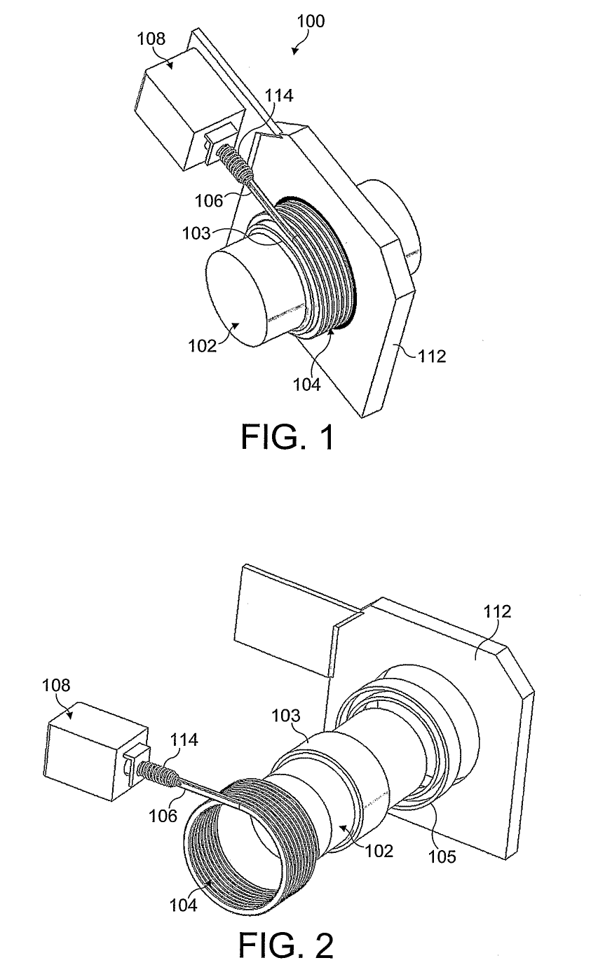

FIG. 1 is a schematic perspective view of a unidirectional brake device for a vehicle transmission;

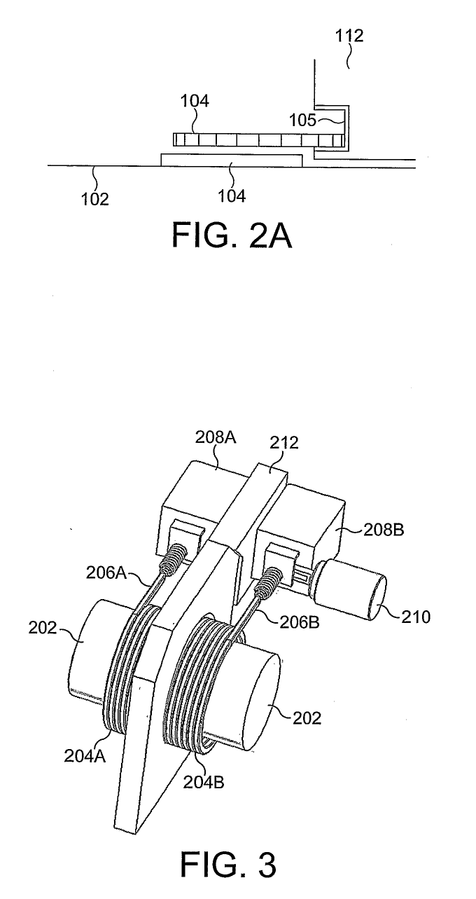

FIG. 2 is an exploded view of the device from FIG. 1;

FIG. 2A is a schematic cross-section of an example of a wrap spring anchored to an external object;

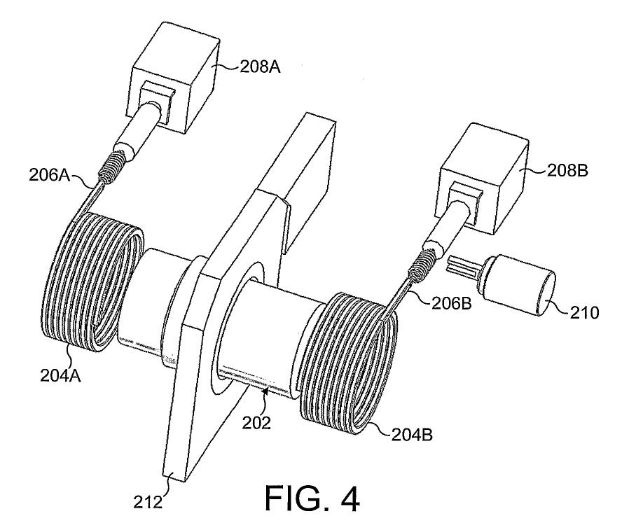

FIG. 3 is a schematic perspective view of a modified anti-roll device for a vehicle transmission;

FIG. 4 is an exploded view of the device from FIG. 3;

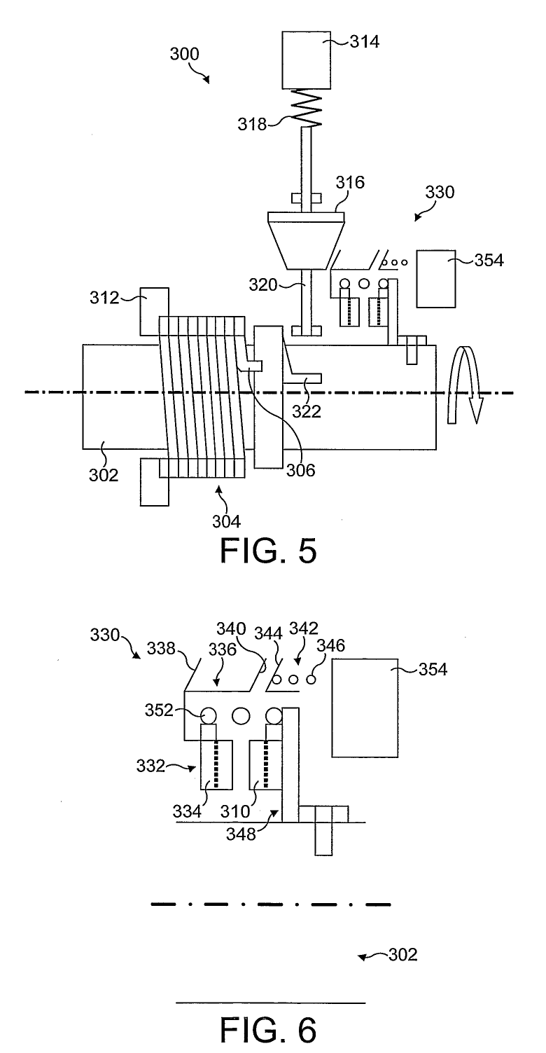

FIG. 5 is a schematic view of part of a further modified anti-roll device for a vehicle transmission;

FIG. 6 is an enlarged view of a speed sensing device for use in the embodiment of FIG. 5;

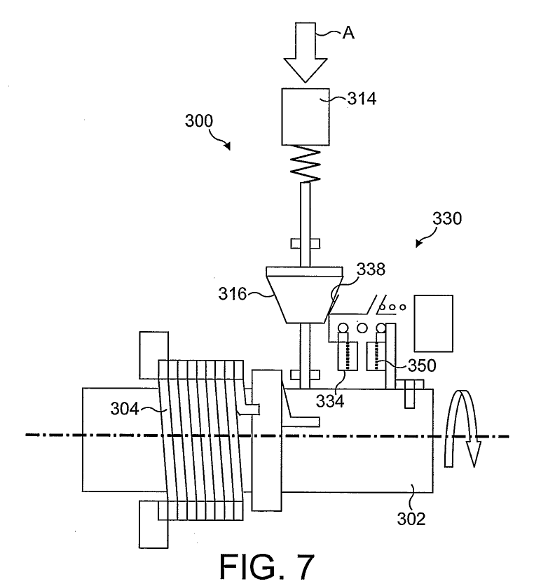

FIGS. 7 to 10 show various stages of the device from FIG. 5 in use;

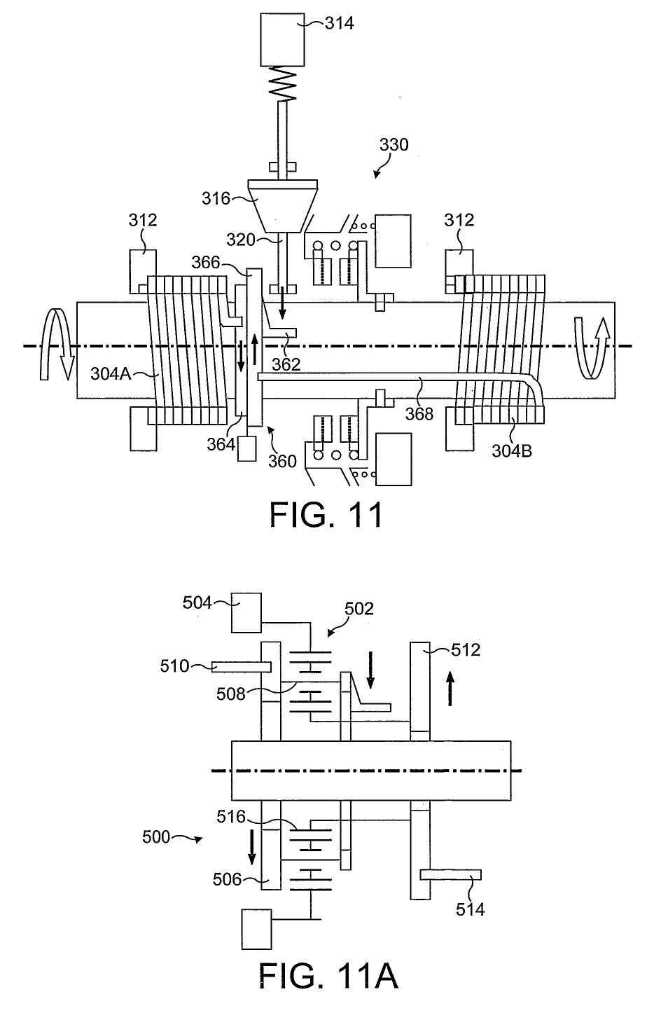

FIG. 11 shows a further anti-roll device, similar to the device of FIG. 5, but including axially spaced opposing wrap sprigs for bi-directional braking;

FIG. 11 is a schematic view of an epicyclic differential arrangement for a split tang ring;

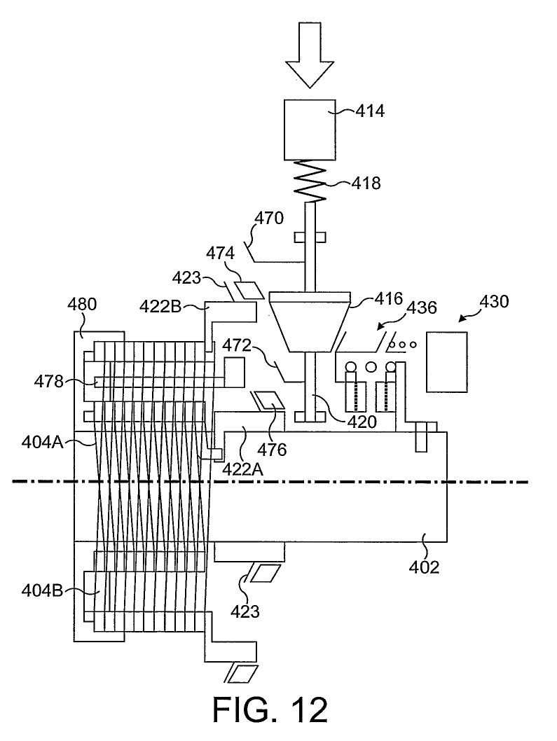

FIG. 12 is a schematic view of a brake arrangement using concentric wrap springs for bi-directional braking;

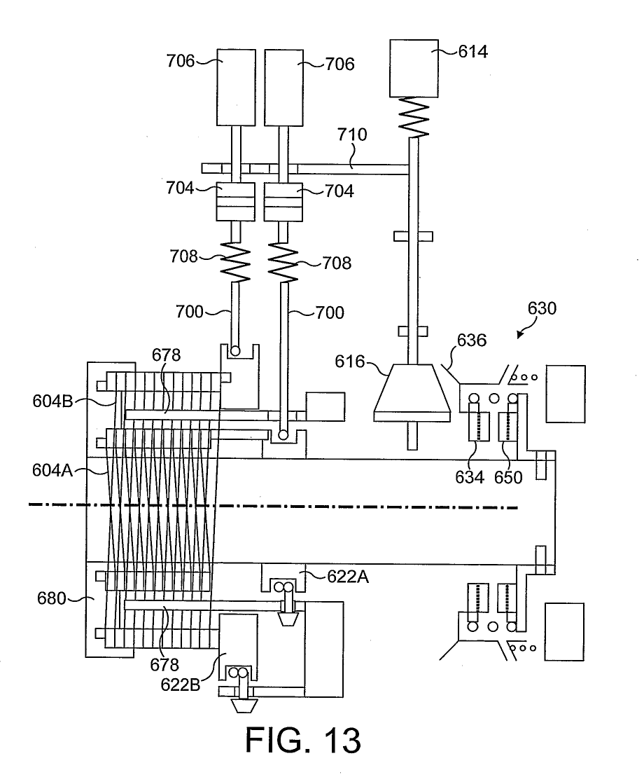

FIG. 13 is a schematic view of a further concentric wrap spring arrangement, including an interlock device; and

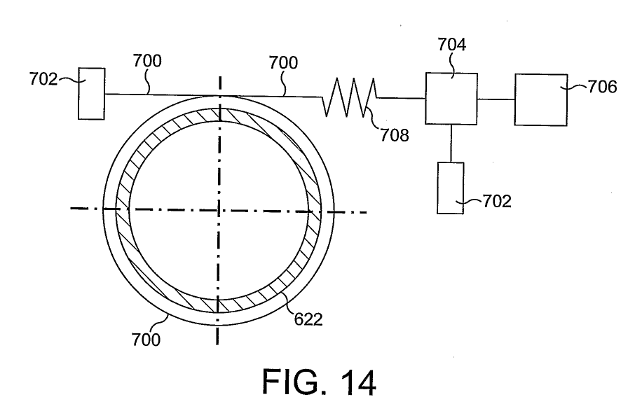

FIG. 14 is a schematic view of a drag torque mechanism for use in the arrangement of FIG. 13.

Referring firstly to FIGS. 1 and 2, a brake device is indicated generally at 100, which includes a wrap spring 104 mounted about an enlarged portion 103 of a rotatable shaft 102. The wrap spring 104 has a coiled configuration of known relaxed diameter, which is greater than the diameter of the enlarged portion 103 so that, under normal operating conditions, the spring is spaced from the shaft 102.

An inner end of the wrap spring 104 is fixedly anchored to a ring 105 or other anchor point separate from the shaft 102. In this embodiment, the ring 105 is formed on part of a transmission casing 112 (see FIG. 2A).

In use, the solenoid 108 can be electrically controlled to pull on the free end 106 of the wrap spring 104, so as to tension the spring 104 about the shaft 102. Upon energising the control device 108, the action of the spring 104 is sufficient to retard or prevent rotation of the shaft 102, by virtue of the high gain between applied force and the retarding torque generated by the wrap spring.

A coil spring 114 is shown between the free end 106 of the spring 104 and the control solenoids 108. However, this may be replaced by an integral connector formed as part of the spring 104. A spacer or other non-magnetic device (not shown) may be provided between the spring and the solenoid.

The device 100 is unidirectional. As such, the device 100 can be used as an anti-roll back device, wherein the spring can be arranged for preventing rotation of the shaft in a reverse direction, e.g. under control from a vehicle ECU or other on-board controller.

The enlarged portion has a hardened coating which is resistant to wear from the spring 104. However, in other embodiments the enlarged portion may be omitted, such that the spring is able to wrap down directly onto the shaft 102

A disadvantage of the device 100 is that the action of the spring 102 may be sufficient to engage the shaft 102 and prevent rotation thereof, even when the shaft 102 is rotating at speed. An alternative device is indicated at 200 in FIGS. 3 and 4, in which two wrap springs 204A, 204B are mounted about the rotatable shaft 202.

Wrap spring 204A is arranged for preventing rotation of the shaft 202 in a first direction, e.g. clockwise, and wrap spring 204B is arranged for preventing rotation of the shaft 202 in the opposite direction. The wrap springs 204A, 204B are connected to respective control solenoids 208A, 208B. Hence, the device 200 offers bi-directional braking, and so is useful as a park brake mechanism for preventing forward and rearward motion of a vehicle.

At least one of the control devices 208A, 208B includes another auxiliary latch or safety device, whereby operation of the control device 208A, 208 can be selectively prevented. In the illustrated embodiment, the auxiliary control device is in the form of an interlock device 210, e.g. a stepper motor, which is arranged to engage the output from solenoid 208B (e.g. a hole in the output shaft of He solenoid 208A) or the free end 206B of the wrap spring 204B, to prevent linear movement thereof and so prevent tensioning of spring 204B about shaft 202.

Sensors may be provided for detecting or monitoring the status of the solenoid, e.g. as part of a vehicle mounted ECU.

In this embodiments wrap spring 204B is arranged for preventing forward motion of the vehicle. Interlock device 210 is provided for preventing accidental or undesired actuation of the spring 204B, to avoid engagement of the shaft 202 when the vehicle is in forward motion. A similar auxiliary control maybe provided for spring 204A.

It will be understood that the embodiment of FIGS. 2 and 3 has application as an anti-roll device and a general park brake device, for preventing rotation of the shaft 202 in either direction.

The solenoid-type control devices described above may be replaced with other linear actuator type arrangements, e.g. a rail or a moving magnet armature, for use in pulling the free end of the or each wrap spring. Other non-linear actuating arrangements may also be applicable for tensioning the or each wrap spring.

Although the springs 204A, 204B in FIGS. 2 and 3 are shown axially spaced on the shaft 202, they may have a concentric arrangement in other embodiments.

In the embodiments of FIGS. 1 to 4, the wrap springs are anchored to an external ground, e.g., to a section of transmission casing, e.g. as shown at 112 in FIGS. 1 and 2 or at 212 in FIGS. 3 and 4. The integrity of the spring structure is sufficient to maintain the a clearance between the spring and the shaft, even when arranged as a cantilever (e.g. as shown in FIG. 2A). The clearance and/or characteristics of the spring is preferably selected so as is prevents self-energising contact of the spring with the shaft under all vehicle driving conditions, e.g. to prevent engagement of the spring on the shaft when the vehicle is on rough terrain or in the event of a collision.

The springs are preferably of steel and more preferably have an anti-corrosion coating. In preferred embodiments, the wrap springs are mounted in a wet environment (e.g. in an oil bath, wherein the lubrication provides a mechanism for reducing wear and removing debris from the engagement zone between the spring(s) and the shaft, so as to prevent snagging or self-energising of the spring(s) about the shaft.

A modified hill hold/anti-roll device is indicated generally at 300 in FIGS. 5 to 12.

Referring firstly to FIG. 5, a wrap spring 304 is mounted about the output shaft 302 of a vehicle transmission, with one end of the spring 304 anchored to part of a transmission casing 312. The spring 304 is arranged for selectively preventing rotation of the shaft 302 in a first direction, to prevent the vehicle from rolling in a predetermined direction (e.g. backwards on a gradient).

The device 300 includes an actuation mechanism 314, which is arranged to act on a conical plunger 316 against the action of a spring 318. The plunger 316 includes an output rod 320 arranged for engagement with a tang ring 322, which is coupled to the free end 306 of the spring 304 and freely mounted about shaft 302.

In use, the actuation device is used to move the plunger 316, downwards as viewed in FIG. 5, until the rod 320 is brought into engagement with the tang ring 322, so as to cause the tang ring 322 to rotate. Movement of the tang ring serves to tension the spring 304 about shaft 302, and thereby retard or prevent rotation thereof.

A safety or speed sensing mechanism 330, seen most clearly in FIG. 6, is included for preventing actuation of the spring 304 if the shaft is rotating at speed, e.g. above 5 km/h. The device 330 is generally annular, although only half of the arrangement is shown in FIGS. 5 and 6.

The device 330 includes an outer dog ring 332 having teeth 334. The outer dog ring 332 is part of an annular cone sleeve 336, concentric with the shaft 302. The cone sleeve 336 has a chamfered lead face 338 and an inclined back face 340. The lead face 338 of the cone sleeve 336 is arranged for engagement with the cone plunger 316. The back face 340 is arranged for engagement with the lead face 342 of a retarding device 344, which is axially movable under toad from the cone sleeve 336, against the bias of a spring 346, in abutment with another part of the transmission casing 354.

The device 330 further includes an inner dog ring 348 having teeth 350. The inner dog ring 348 is axially fixed, as well as fixed for rotation with the shaft 302.

The cone sleeve 336 is biased against axial movement by a further spring 352, which abuts against the fixed inner dog ring 346.

Operation of the device 300 will now be described with reference to FIGS. 5 to 10.

Actuation force (as indicated by the arrow A in FIG. 7) causes the plunger 316 to move radially inwards (downwards as viewed in FIG. 7) until it engages the leading edge 338 of the cone sleeve 336 of the speed sensing device 330.

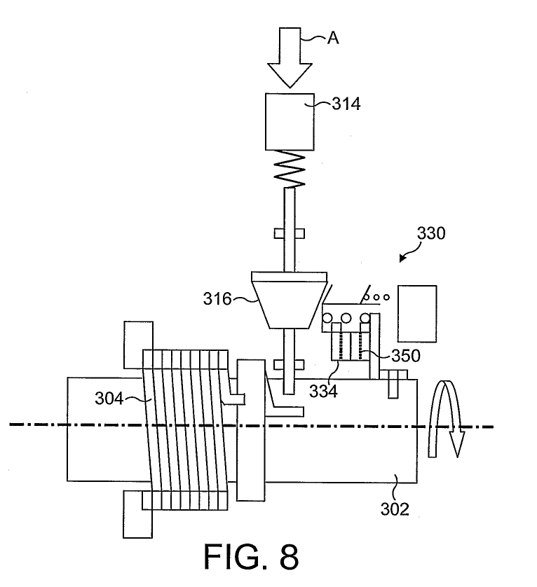

The cone spring 336 moves axially against the bias of spring 352, until the rear face 340 of the cone sleeve 336 abuts the lead face 344 of the retarding device 342. This brings the teeth 334, 350 of the outer and inner dog rings 332, 348 into contact with one another. However, the geometry of the teeth 334, 350 is specifically configured such that, if the shaft 302 (and hence the inner dog ring 348) is rotating at speed, the teeth 334, 350 cannot engage, and instead clash. Therefore, the plunger 316 is blocked against further radial movement (downwards as viewed in FIG. 8) under the actuation force A, because the cone sleeve 336 is blocked against further axial movement (i.e. to the right as viewed in FIG. 8).

Initial contact with the retarding device 342 applies a drag torque to the outer dog ring, to slow its rotation (if any). A spring 334 in the drag device is compressed by further motion of the conical plunger 316.

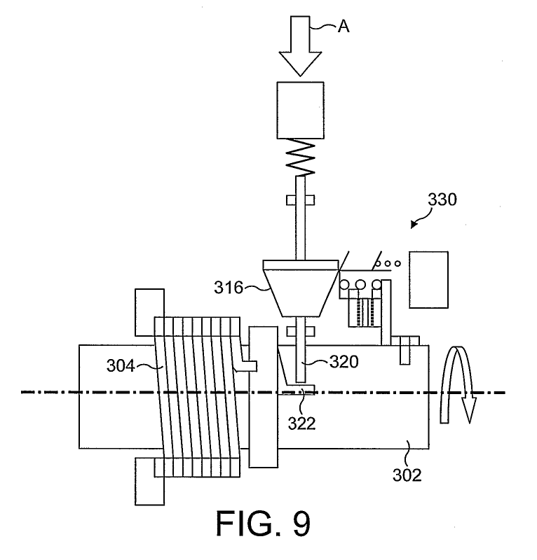

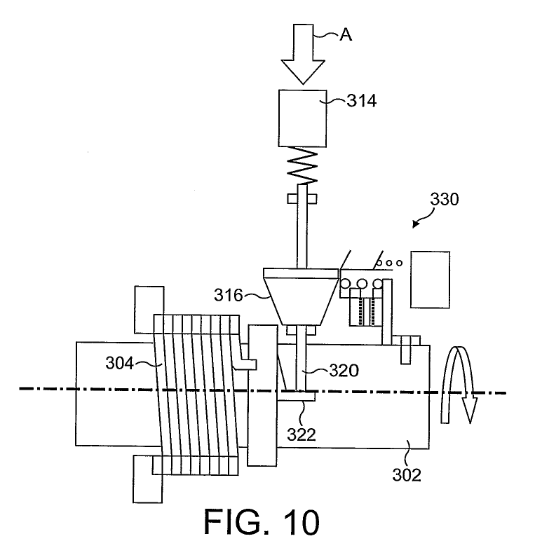

At a predetermined relative speed, the geometrical configuration of the teeth 334, 350 permits the teeth to move into meshing engagement, whereupon the sleeve 336 is able to move axially under load from the plunger 316, so that the plunger 316 is free to move radially inwards, as shown in FIG. 9. Hence, the rod 320 is then able to drive against the tang ring 322, so as to tension the spring 304 about the shaft 302 (see FIG. 10).

The actuation mechanism 314 preferably takes the form of a linear actuator and more preferably a bi-stable latching device, which is configured for locking the plunger in its deployed position Hence, the wrap spring 304 can be maintained in tension about the shaft 302 without the supply of power to the device 314. A further application of power can then be used to release the plunger 316 from its latched position, so as to permit rotation of the shaft 302.

Another embodiment is shown in FIG. 11, similar to the arrangement of FIG. 5, but including opposing wrap springs 304A, 304B for preventing rotation of the shaft 302 in both directions. In this embodiment, spring 304A is wound in a counter clockwise sense and spring 304B is wound in a clockwise sense, for example.

Each spring 304A, 304B may include its own actuator 314 and plunger 316. However, the illustrated embodiment includes a modified tang ring assembly 360, wherein the spring 304B is operated by the same actuator 314 as the spring 304A.

Operation of this embodiment is generally the same as for the embodiment of FIG. 5, particularly with respect to the speed sensing device 330. The key differences are discussed below.

In use, actuator rod 320 is arranged for driving against a free end 362 of a first portion of the tang ring, indicated at 364 in FIG. 11, so as to rotate tang ring portion 364 about the shaft 302. Spring 304A is connected to tang ring portion 364. Therefore, if tang ring portion 364 is rotated so that free end 362 moves downwards as viewed in FIG. 1, spring 304A is caused to constrict around the shaft 302, so as to brake the shaft 302 against rotation in a first direction.

At the same time, a second portion of the tang ring, indicated at 366 in FIG. 11, is caused to rotate in the opposite direction. A link member 368 is fixed for rotation with the second portion 366 and couples spring 304B for rotation therewith. Indeed, the link member may be an integral tang or part of the spring 304B. As such, rotation of the second portion 366 of the tang ring causes the spring 304B to constrict, so as to brake the shaft 302 against rotation in an opposite sense to spring 304A. Hence, bi-directional braking is achieved.

In a preferred embodiment the bi-directional movement of the tang ring portions 364, 366 is achieved using a small epicyclic differential arrangement having a ring gear, planet gear, sun gear, and planet carrier. The ring gear is anchored to ground (e.g. to part of the transmission casing), wrap spring 304A is attached to the planet carrier and wrap spring 304B is attached to the sun gear. In use, the plunger rod 320 acts on the planet carrier, and the sun gear is rotated in the opposite sense.

An example of a suitable epicyclic differential arrangement for a split tang ring is shown at 500 in FIG. 11A, wherein a ring gear 502 is anchored to a ground 504 (e.g. a portion of the transmission casing), a first tang ring portion 506 is attached to a planet carrier 508 for driving one end 510 of a first wrap spring 304B, and a second tang ring portion 512 is attached to a sun gear 516 for driving one end 514 of a second wrap spring in the opposite sense.

Alternatively, a pivoting lever arrangement may be used for driving the tang portions in opposite directions.

In each of the above embodiments, only ‘wrap down’ (i.e. constricting) springs have been described. However, these may be replaced with ‘wrap out’ springs, e.g. which are able to expand and abut against a concentric wall, for example.

One example is shown in FIG. 12, in which concentric wrap springs 404A, 404B are mounted about a rotatable shaft 402, and wherein the inner spring 404A is an expanding type spring and the outer spring 404B is a constricting-type spring.

A plunger assembly and speed sensing device 430 is included, having generally the same construction and method of operation as sensing device 330 from FIGS. 5 and 11. Hence, plunger 416 is prevented from moving to a spring energising position if the shaft 402 is rotating above a predetermined speed.

A pair of friction arms 470, 472 extend axially from the plunger assembly, each having an angled lead face which is arranged for cooperation with a respective actuator cone 474, 476, whereupon the cones 474, 476 are axially movable to engage an associated tang ring 422A, 422B of a respective spring 404A, 404B.

The springs 404A, 404B are arranged concentric with the shaft 402 by virtue of a cantilever connection (e.g. as shown in FIG. 2A) to a collar 480, which is mounted for rotation with the shaft 402.

In use, the shaft 402 rotates, and hence the coils 404A, 404B are caused to rotate with the shaft, via the collar 480. Frictional contact between in the cones 474, 476 and the tang rings 422A, 422B is suitable to generate a drag toque, whereupon springs 404A, 404B are arranged to expand/constrict accordingly. An annular ground member 478 (only one side of which is shown in FIG. 1) is fixedly arranged between the coils 404A, 404B, concentric with the shaft 402, such that the coils are able to expand/constrict accordingly against the ground, so as to brake the shaft 402 against rotation. The coils 404A, 404B are wound in opposite ensure, so as to ensure bidirectional braking of the shaft 402.

An annular latching mechanism may be provided for selectively latching fingers 423 on the tang rings 422A, 422B, so as to hold the tang rings in a tension/compression inducing state.

FIG. 13 shows a similar concentric wrap spring arrangement to FIG. 12, and similar reference numerals are used for corresponding components, albeit with the prefix 6______ instead of 4______.

In this embodiment, drag torque is induced in the tang rings 622A, 622B by a looped connection, shown by way of example in FIG. 14. A loop of spring wire 700 is formed around the tang ring. One end of the spring wire is attached to a ground at 702, e.g. a portion of the transmission case and the other end to a tension spring 708. In a relaxed state, the spring wire forms a coil (of one or more turns) about the tang ring 622. The coil has a circular form of greater diameter than the tang ring, to prevent accidental contact of the spring wire with the tang ring.

A bistable (e.g. flip flop) mechanism 704 is mounted on the casing 702 and coupled to he tension spring 708. A pull type actuator (e.g. a solenoid 706) is arranged for actuating the mechanism 704, in order to pull on the spring wire 700 and thereby constrict the loop(s) around the tang ring, so as to generate a drag torque.

In the embodiment of FIG. 13, independent operation of the tang rings 622A, 622B is achieved, using a separate retarding arrangement (e.g. as shown in FIG. 14) for each tang ring.

An interlock 710 is provided for preventing operation of the drag torque mechanisms when the shaft 602 is rotating at speed. The interlock cooperates with the speed sensing device 630, which in this embodiment uses a pull-type actuator 614 in order to raise the plunger 616 against the cone sleeve 636. Only when the teeth 634, 650 are in mesh is the plunger free to move upwards, so as to move the interlock from a blocking position. Hence, when the plunger 616 is moved upwards from the position in FIG. 13 are the actuators 704 operable to tension the spring wires 700.

1. A vehicle transmission incorporating a brake device, the vehicle transmission including an output shaft and the brake device including a wrap spring mounted around said shaft, wherein the wrap spring is arranged for moving from a relaxed state to an energised state for braking rotation of the shaft.

2. A vehicle transmission according to claim 1 wherein the shaft forms part of the output shaft of the transmission.

3. A vehicle transmission according to claim 1 wherein the transmission includes a transmission casing, and wherein the brake device is housed within the casing.

4. A vehicle transmission according to claim 1 wherein the wrap spring is arranged to constrict for engagement on the shaft.

5. A vehicle transmission according to claim 1 wherein the wrap spring is arranged to expand for engagement with an adjacent ground member.

6. A vehicle transmission according to claim 1, including a pair of wrap springs arranged for bidirectional braking of the shaft.

7. A vehicle transmission according to claim 6 wherein the wrap springs concentric with one another.

8. A vehicle transmission according to claim 6 wherein the wrap springs are axially spaced from one another along the shaft.

9. A vehicle transmission according to claim 8, including a single input for actuating both wrap springs.

10. A vehicle transmission according to claim 9, including a ring arranged for receiving input from said actuator, the ring having a first portion movable to energise a first of said wrap springs and a second portion movable to energise a second of said wrap springs.

11. A vehicle transmission according to claim 10 wherein an epicyclic differential arrangement is provided for moving the first and second ring portions in opposite directions.

12. A vehicle transmission according to claim 1 wherein a wrap spring is mounted in a relaxed state for rotation with the shaft, and a mechanism is provided for inducing a drag torque at a free end of the spring, in order to energise the spring for a braking operation.

13. A vehicle transmission according to claim 12 wherein the drag torque mechanism includes a ring which is attached to one end of the wrap spring and is rotatable about the shaft, and a loop or coil arranged annular to said ring, wherein the loop or coil can be tensioned and brought into contact with the ring, in order to create drag on the ring and thereby energise the wrap spring.

14. A vehicle transmission according to claim 1, further including an actuator for energising the wrap spring and a safety mechanism arranged for selectively disabling the energising operation of the actuator.

15. A vehicle transmission according to claim 14, the device further including a safety mechanism arranged for selectively preventing movement of a free end of the wrap spring.

16. A vehicle transmission according to claim 15 wherein the safety mechanism is in the form of an interlock device for locking engagement with a free end of the actuator or wrap spring.

17. A vehicle transmission according to any preceding claim, further including an actuator element which is movable for energising the wrap spring, and a mechanism configured for preventing operation of the actuator if the shaft is rotating above a predetermined speed.

18. A vehicle transmission according to claim 17 wherein the mechanism includes a blocking element which is arranged to block movement of the actuator element when the shaft is rotating at speed.

19. A vehicle transmission according to claim 18 wherein mechanism includes opposing dogs that are configured to inter-engage only when the shaft speed is below a predetermined threshold, in order to permit the blocking element to move from a blocking position to a non-blocking position.

20. A brake device including a wrap spring mounted around a rotatable shaft, wherein the wrap spring is arranged for moving from a relaxed state to an energised state for braking rotation of the shaft.

21. A brake device according to claim 20, the device including first and second wrap springs mounted about the shaft, wherein the first wrap spring is arranged for selectively preventing or retarding rotation of the shaft in a first sense, and wherein the second spring is arranged for preventing or retarding rotation of the shaft in an opposite direction.

22. A brake device according to claim 20, including a latching mechanism, which is operable to selectively hold the spring in an energised state.
